(19) United States
(12) Patent Application Publication
(10) Pub. No.: US 2010/0266204 A1
(43) Pub. Date: Oct. 21, 2010

(54) METHOD AND SYSTEM FOR THREAT IMAGE PROJECTION

(75) Inventors: Vladimir Ivakhnenko, Norton, MA (US); William Aitkenhead, Sharon, MA (US)

Correspondence Address: MINTZ, LEVIN, COHN, FERRIS, GLOVSKY AND POPEO, P.C, ONE FINANCIAL CENTER, BOSTON, MA, 02111, US

(73) Assignee: Reveal Imaging Technologies, Inc., Bedford, MA (US)

(21) Appl. No.: 12/762,217

(22) Filed: Apr. 16, 2010

Related U.S. Application Data
(60) Provisional application No. 61/170,462, filed on Apr. 17, 2009.

(51) Int. Cl. G06K 9/34

(52) U.S. Cl. 382/173

(57) ABSTRACT

A method and system for Threat Image Projection (TIP) data collection and image transformation of the TIP image data for inserting threat images in images of scanned objects, such as scanned luggage. A few scans for each threat object at predefined orientations can be stored in the system database and the system can transformed this image data to closely correspond to arbitrary threat positions in the tunnel. The transformed images can provide a close approximation in accuracy to images obtained by direct scanning at the corresponding appropriate location in the tunnel. The image data in the TIP image database can be scaled for use in other systems that have different geometries from the original system in which they were generated.

### CROSS-REFERENCE TO RELATED APPLICATIONS

This application claims any and all benefits as provided by law of U.S. Provisional Application No. 61/170,462 filed Apr. 17, 2009, which is hereby incorporated by reference in its entirety.

### STATEMENT REGARDING FEDERALLY SPONSORED RESEARCH

Not Applicable

### REFERENCE TO MICROFICHE APPENDIX

Not Applicable

### BACKGROUND

1. Technical Field of the Invention

The present invention is directed to Threat Image Projection (TIP) and more particularly to a method and a system for transforming images of threats to be projected into images of scanned objects.

2. Description of the Prior Art

Digital radiography scanners are widely used for scanning canyon luggage, clothing and other canyon items at security checkpoints to be sure that they do not contain threats (e.g. weapons and explosives) and any other prohibited items. Statistically, events involving real threats in luggage or other carryon items happen rarely. As a result, the operators at the check point can lose their concentration and miss real threats. In order to help the operator to stay alert and to control his activity, threat image projections (TIPs—images of threat objects) can be artificially inserted into the checkpoint images by the scanning system software (SW). In most prior art systems, TIPs data is generated by scanning various threat objects at certain positions in the tunnel of the scanner and its images (overhead and side) are recorded and stored in the TIPs database. The prior art software takes one of the TIP images from the TIP database and inserts it into the empty space of the luggage image and presents the combined image on the operator's screen.

This approach in TIP data collection/presentation suffers from the several drawbacks. It requires the system to include a large database of TIP data for each object at each possible location within the luggage or other checkpoint canyon item. While this approach provides for more realistic and indistinguishable presentations if TIPs, it added to the operational overhead of the system requiring large amounts of data storage and significant time to search for and retrieve the most appropriate TIP image data. Further, it requires significant effort to scan objects at many different orientations in order to generate the TIP database. Alternatively, a smaller database of TIP data can be used, but with a corresponding limited ability to insert images in many locations and the possibility that the images will not appear similar to a real image and thus, easily distinguishable from a real threat.

It is possible to scan the same threat object at many different locations in the tunnel's cross-section and store the scanned images in a TIPs database. But this approach is time consuming as it requires a lot of scans to be done for each threat at different positions and elevations inside the tunnel. Further, the average size TIPs database consists of several thousand threats, and this brute force approach requires an enormous amount of time to scan all the threat objects as each position and results in a very large TIP database.

### SUMMARY

The present invention is directed to threat and explosives detection systems and methods that can project images of threats in to images of objects being scanned. These systems can include a system or subsystem that project the image of the threat in to the image of the object at a predefined or random location, randomly or at a predetermined time or number of objects scanned. In accordance with the invention, only a relatively small number of scans of each threat object would need to be obtained and stored in the TIP database and the stored TIP image data can be transformed to present the most correct orientation for any point in the tunnel cross-section. Preferably, the transformed TIP image should be visually indistinguishable from the one obtained by direct scanning at this position and the algorithm should be able to provide the TIP transformation in real time, so as not to delay presentation of the scanner image and possibly indicate the presence of a TIP.

The present invention is directed to a method and system for TIP data collection and a method and system for threat image transformation, including an algorithm that enables the system to create in real time, a realistic TIP at any location in the tunnel cross-section. In accordance with the invention, an object scanner includes a conveyor belt that transports the object through the scanner that directs radiation at the object and includes one or more arrays of detectors that measure transmission of the radiation through the object. The detector array(s) and the conveyor are connected to a computer that is adapted to control the movement of the conveyor and receive data signals from the detector array(s). The computer can include computer software that can process the data signals and produce an image of the object allowing the operator to view the contents of the object. In order to project images of threats into the images of objects scanned by the scanner, a database of threat images is created by scanning real or simulated threat objects using the scanner. In accordance with the invention, the object is held in position using a jig or fixture that supports the object on the conveyor in the desired orientation. In addition the jig or fixture can be constructed of a material that is substantially transparent to the radiation or can be easily identified and removed from the resulting image.

In accordance with one embodiment of the invention, the real or simulated threat object can be positioned in the center of the conveyor belt and scanned by the scanner to produce an image in a first angular orientation that can be stored in the TIP database along with information indicating the angle of orientation. In accordance with the invention, the jig or fixture can include an adjustable platform that allows the real or simulated threat object to be positioned at different angles and images of the threat object in several angular orientations can be created and stored in the TIP database along with information indicating the associated angle of orientation. Alternatively, the threat object can be held at the same angular orientation and scanned at different positions on the belt horizontally transverse to the direction of motion to simulate different angles of orientation. In accordance with one embodiment, the range of angles of orientation can be limited to maximum angles of the fan beams of radiation that are used by the scanner.

The database of TIP images can be stored in non-volatile memory in the scanner computer system and accessed randomly under software control. The computer system can include algorithms that can determine whether or not a TIP will be applied to any given object that is scanned as well as the specific type of threat to be used and the location of the TIP in the scanned object. In accordance with the invention, the computer system software can select a location of for the TIP and then analyze the object image to determine whether it would appropriate to insert the TIP at the selected location. For example, the system would select a different location if it were determined that there is a dense object in the selected location that would be incompatible with the insertion of the threat object.

In accordance with one embodiment of the invention, a system is provided for scanning objects and providing an image of the object on a display. The object can, for example, include canyon items including luggage or baggage of any shape or size. The system scans the object with radiation and uses the sensors to detect the radiation passing through the object and generates an image of the contents of the object. In addition, the system can be provided with a Threat Image Projection (TIP) system or subsystem that can insert an image of a threat into a selected location of the image of the object at a predefined or random time. The TIP System determines the location and the orientation of the threat in the object being scanned. The TIP System includes a TIP database containing one or more and preferably three or more images of the threat object, each image at a different angle of orientation.

In accordance with one embodiment of the invention, after the TIP System determines the location and angle of illumination of the threat, the TIP System searches its threat database for images of the threat object that were take at an angle of illumination close to the determined angle of illumination of the TIP. The TIP System can select the image of the threat object that corresponds to an angle of illumination with the smallest difference from the determined angle of illumination. Next, the TIP System can scale the size of the image of the threat as a function of the determined location of the threat in the image of the scanned object.

In accordance with the invention, the TIP system can determine the threat type of the TIP image to be projected into the image of the object and select the location of the TIP image. In accordance with the invention, the TIP system can use the selected location of the TIP image to determine the angle of illumination of the threat as well as the scaling factor for the TIP image. Next, the TIP system can compare the determined angle of illumination with the illumination angles associated with the images in the TIP database and select the image from the database having the closest illumination angle. Next, the TIP system can apply the scaling factor to reduce or enlarge the size of the TIP image and insert the TIP image into the image of the scanned object. The user interface of the scanning system can include a button, switch or other control that allows the operator (the security screener) to indicate the presence of a threat in the object. Actuating the button, switch or control can provide an indication to the operator that the threat was a projected image. Failure to actuate the button, switch or control can also provide an indication that the user missed the TIP as well as provide a highlighted (e.g. brighter intensity or blinking) image of the TIP to help the operator learn from their mistakes.

Thus, the present invention provides for systems and methods for projecting realistic images of threats in to images of scanned objects that assist in keeping the security screening personnel alert and provide more realistic training at the same time. These and other objects of the invention will be apparent from the drawings and description provided herein.

### BRIEF DESCRIPTION OF THE FIGURES

FIGS. 1A and 1B show overhead images of a Lucite step wedge scanned in the same orientation at two different positions on the belt: FIG. 1A shows the wedge at the bottom left corner of tunnel cross-section; FIG. 1B shows the wedge at the bottom right corner of tunnel cross-section. The arrows indicate the direction of the belt.

FIGS. 2A and 2B show overhead images of an aluminum step wedge scanned in the same orientation at two different positions in the tunnel: FIG. 2A shows the wedge at the bottom left corner of the tunnel cross-section; and FIG. 2B shows the wedge at the top left corner of tunnel cross-section. The arrows indicate the direction of the belt.

FIG. 3 shows a diagram of the tunnel's cross-section and provides a geometric representation of the TIP object, from the perspective of the bottom x-ray source, in accordance with the invention.

FIG. 4 shows a diagram of the tunnel's cross-section and provides a geometric representation of the TIP object, from the perspective of the side x-ray source, in accordance with the invention.

FIG. 5 shows that different orientations of a rectangular object at point O₁ for overhead and side images have to be used to provide correct overhead and side images for rectangular object located at point O₃, in accordance with the invention.

FIG. 6 shows the optimal choice of the point O₁ for a multi-view CT scanning system, in accordance with the invention.

FIG. 7 shows a system for inserting TIP images in accordance with the invention.

FIG. 8 shows a flow chart of a method in accordance with the invention.

FIG. 9 shows the geometry of tunnel's cross-section for a smaller multi-view CT scanning system and a larger multi-view CT scanning system, in accordance with the invention.

FIGS. 10-13 show a comparison of TIPs images generated in accordance with the invention and actual threat objects positioned in substantially the same position in the tunnel.

### DETAILED DESCRIPTION OF PREFERRED EMBODIMENTS

The present invention is directed to threat and explosives detection systems and methods that can project images of threats in to images of objects being scanned. These systems can include a system or subsystem that project the image of the threat in to the image of the object at a predefined or random location, randomly or at a predetermined time or number of objects scanned. These systems can include TIP database, a database of images of various threat objects or categories of objects. Some of these scanning systems can take multiple views of the object as it travels along the conveyor belt, for example, including a top or overhead view as well as side view of the object. These systems can include TIP images in the TIP database for all views (e.g., top and side view images).

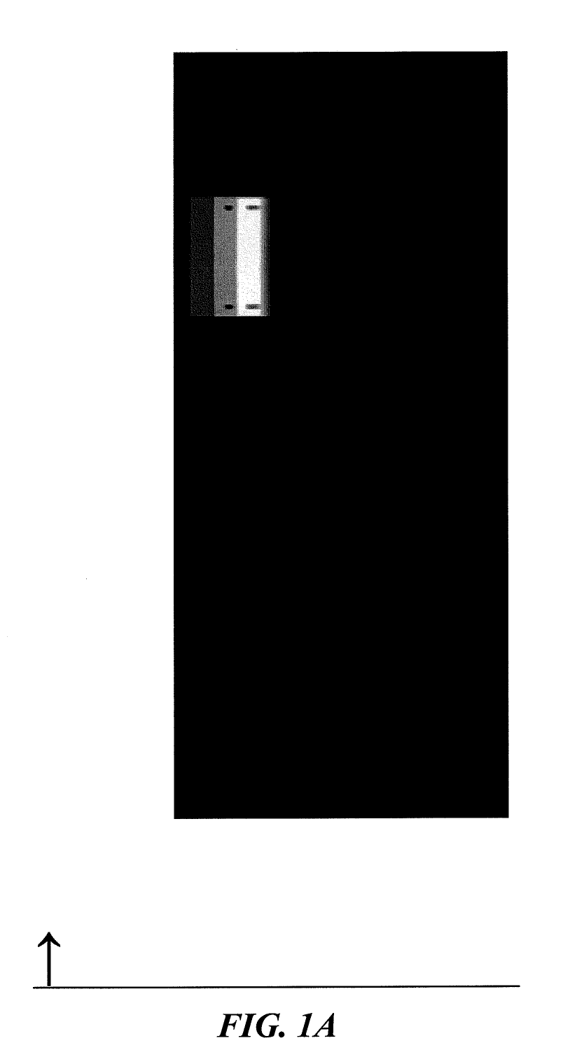

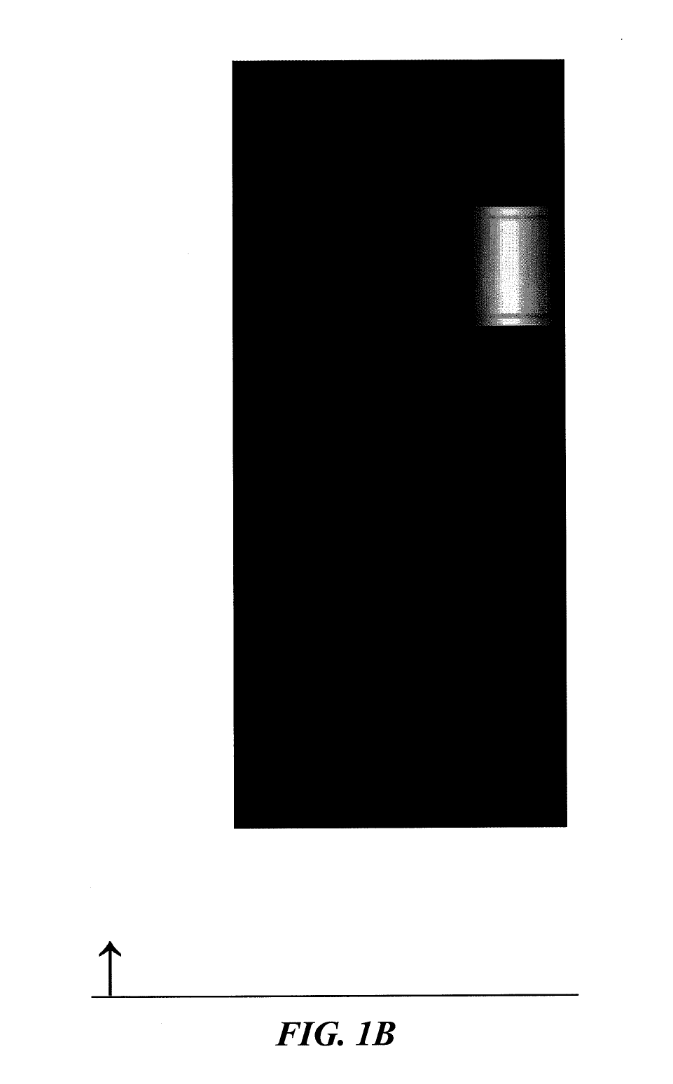

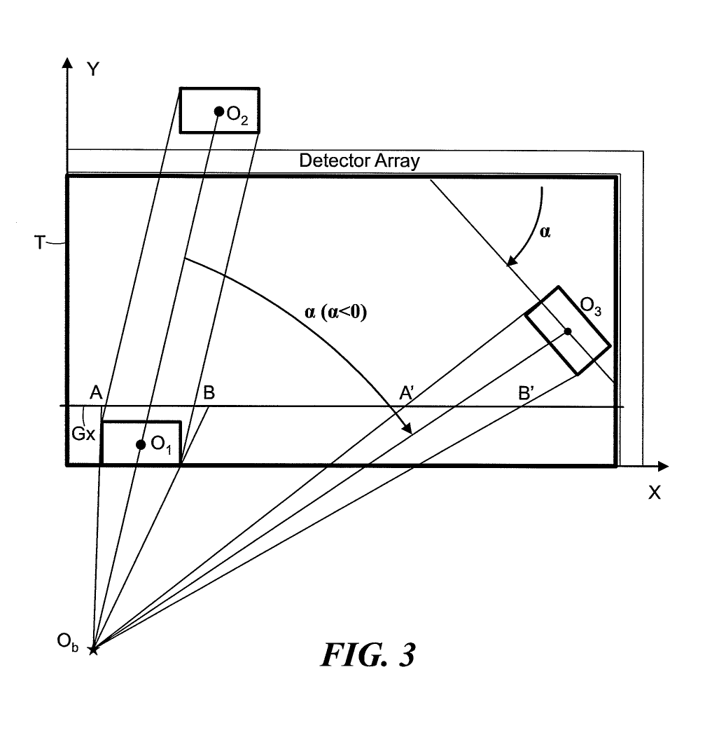

In each view, the size and appearance of the TIP image depends on the location of the threat in tunnel's cross-section with respect to the illumination (radiation) source. This concept is illustrated FIGS. 1A and 1B which show overhead images of the same object scanned at the left and right bottom corners of the tunnel shown. FIG. 1A shows an image of a Lucite step wedge scanned at the bottom left corner of the tunnel. As can be seen, the steps are clearly discernable in FIG. 1A. FIG. 1B shows an image of the same Lucite step wedge scanned at the bottom right corner of the tunnel. As can be seen, the steps are not clearly discernable in FIG. 1B. This phenomenon is due to the angle of illumination of the object. As shown in FIG. 3, the bottom radiation source Ob illuminates objects in the lower left corner (e.g. O1 and the step wedge in FIG. 1A) from substantially directly below, where as objects in the lower right corner (e.g. O3 and the step wedge in FIG. 1B) are illuminated from a substantial angle α compared to the lower left corner. As will be explained further, determining the angle of illumination can provide for a more accurate TIP.

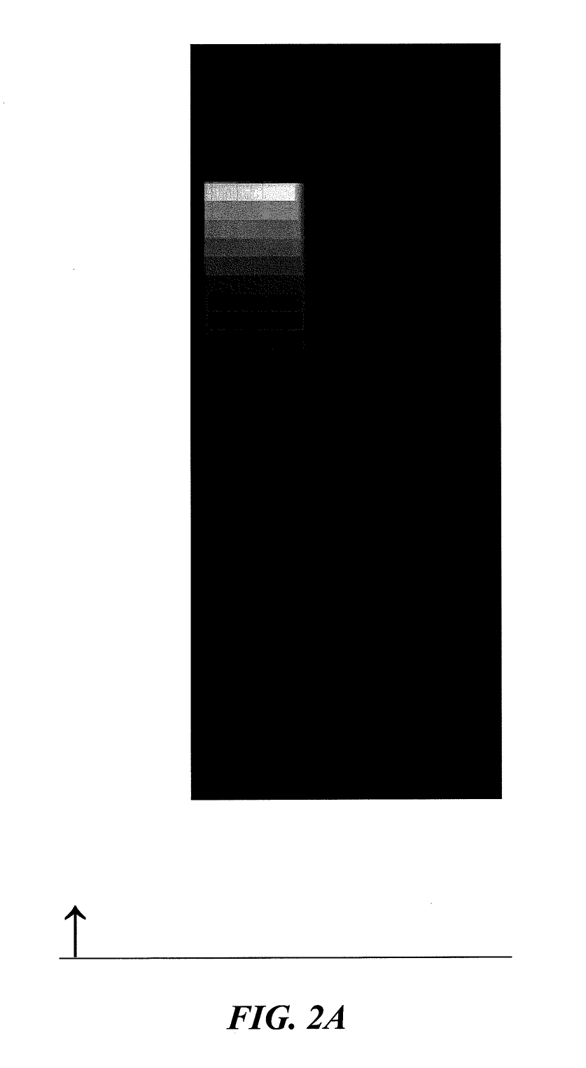

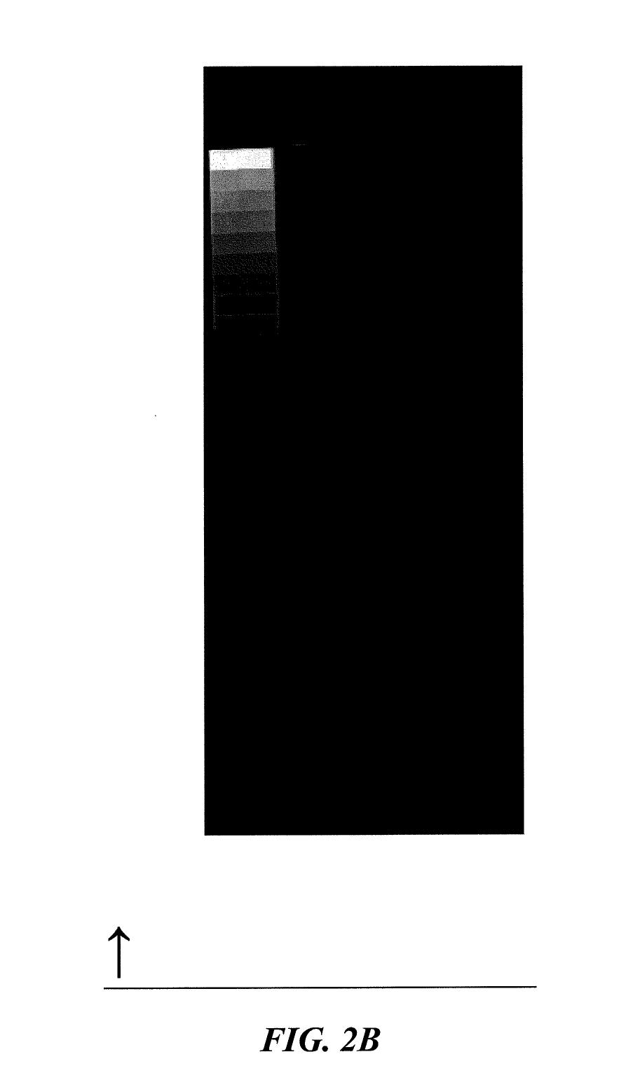

In addition to the angle of illumination, the distance or height of the object in relation to the conveyor belt and the radiation/illumination source is related to the size of the image produced. FIGS. 2A and 2B illustrate that image size depends on object location with respect to radiation source. FIG. 2A shows an image of an aluminum step wedge scanned at the lower left corner of the tunnel. FIG. 2B shows an image of the same aluminum step wedge raised 21 cm above the conveyor. In comparison, the step wedge appears larger when it is closer to the radiation sources (FIG. 2A) and smaller as it moved away from the radiation source (FIG. 2b).

Thus, both size and intensity distribution of TIP image depend on the selected location of the threat image in the tunnel. If the TIP system software does not modify the TIP image in accordance to its location in the tunnel, the TIP does not look realistic on the operator's screen. This can lead to the following negative consequences: 1) the unrealistic TIP appearance surrounded by the real bag background could make the TIP distinguishing decision easier for operator than in the case of a real threat; and 2) the use of TIPs helps to keep the operator alert and can be used to train the operator about the appearance of many different threats. The unrealistic TIPs can mislead operator and unrealistic or easily distinguished TIPs do not provide effective training.

In accordance with one embodiment of the invention, the tunnel T cross-section can be considered orthogonal to the belt and coincide with the central overhead detectors array of multi-view CT scanning system. The multi-view scanning system can include a single radiation source O_{b} as shown in FIG. 3 and two or more detect arrays as, such as described in Evans, J. P. O., Kinetic Depth Effect X-Ray (KDEX) Imaging for Security Screening, 2003 IEEE Conf. on Visual Information Engineering, 2003, which is hereby incorporated by reference. In accordance with the invention, the system can assume that the threat is bounded in space by a virtual rectangular box of appropriate width and height with the center of the box at the point O₁ as shown in FIG. 3. (Only the virtual rectangular box that includes threat is shown on this figure). The X-ray source can be located at the point O_{b} below the tunnel T. This source illuminates the threat and the signals recorded by the array of detectors are transformed into the image in geo-corrected plane Gx. The trace of the geo-corrected plane Gx in the tunnel T cross-section plane is shown on FIG. 3. The conical projection (with the center at point O_{b}) of rectangular box on geo-corrected plane Gx can be denoted by interval AB. As long as the threat is located inside the tunnel T, its geo-corrected projection extends along the interval AB.

In accordance with the invention, the system can transform the image taken of the threat at point O₁ to the arbitrary chosen point O₃ in the tunnel and to obtain the X-coordinate geo-corrected image of the threat at this point. The exact threat geometry can be rather complex and the requirement to know the geometry for image transformation can be burdensome. To overcome this problem, in accordance with one embodiment of the invention, the system can extend the boundary of the threat (using air) to the shape of a rectangular box that encompasses the threat object. From the physical point of view, the system does not change, but from the mathematical point of view, the problem becomes simplified. The extended threat has a rectangular shape and the problem is reduced to obtaining the relation between the geo-corrected images for rectangular boxes located at points O₁ and O₃.

The object transformation between these points could be done by numerous ways in accordance with the invention. Some transformations can lead to significant image intensity distortion (as shown by FIGS. 1A and 1B), while others provide for image adjustment using a scaling factor (see FIGS. 2A and 2B). As noted, the distortion in image intensity occurs when the object in the tunnel T is illuminated by the X-ray source from significantly different angles in the initial location as compared to the final locations. In accordance with one embodiment of the invention, transformations with minimal image intensity distortions can be easily generated using the appropriate scaling factors. In accordance with alternate embodiments of the invention, the process can include one or two transformations that 1) either have minor image intensity distortions or 2) do not have image intensity distortions at all.

FIG. 3 shows the process for transforming the TIP image of an object taken at point O₁ to point O₃. The first transformation is the parallel translation of rectangular box located at the point O₁ in the direction of vector O_{b}O₁ to point O₂ where the distance from O_{b} to O₂ is the same as the distance from O_{b} to O₃ (or where the distance |O_{b}O₂| is the same as the distance |O_{b}O₃|). Taking into account that the length |O_{b}O₁| is significantly greater than the side of rectangular box, this transformation may lead to minor image intensity distortions that could be neglected.

The second transformation involves the rotation of the image in the tunnel T cross-section plane about the center of rotation at the point O_{b}. Due to the mathematical property of rotation (it preserves the angles of orientation with respect to the center point) this transformation does not inject any image intensity distortions at all.

We can transform rectangular box from the point O₁ to the point O₃ in the tunnel using the following steps.
1. Parallel translation from the point O₁ to the point O₂, where vector O_{b}O₂ is defined by the condition:

$${O}_{b} {O}_{2} = {O}_{b} {O}_{1} \frac{\vert {O}_{b} {O}_{3} \vert}{\vert {O}_{b} {O}_{1} \vert} . \qquad ( 1 )$$

The vertices \tilde{r}ᵢ of rectangular box at the point O₂, are defined from the vertices rᵢ of rectangular box at the point O₁ by formula

\tilde{r}ᵢ=O_{b}O₂−O_{b}O₁+rᵢ (2)
2. Rotation about the center of rotation at the point O_{b} by the angle α, where

$$α = arc sin ( \frac{[ {O}_{b} {O}_{1} , {O}_{b} {O}_{3} ] {e}_{z}}{\vert {O}_{b} {O}_{1} \vert \vert {O}_{b} {O}_{3} \vert} ) \qquad ( 3 )$$

Positive angles turn in the counterclockwise direction. The vertices rᵢ′ of the rectangular box at the point O₃, are related to the vertices \tilde{r}ᵢ of rectangular box at the point O₂ by rotation matrix: rᵢ′=R_{α}\tilde{r}ᵢ, where

$${R}_{α} = ( \begin{matrix}cos α & - sin α \\ sin α & cos α\end{matrix} ) \qquad ( 4 )$$

These formulas help to describe the relationship between the vertices of the rectangular boxes at the points O₁ and O₃. The intersections of lines O_{b}rᵢ with X-coordinate geo-corrected plane Gx provide interval AB for overhead image of threat located at point O₁, whereas intersections of lines O_{b}\tilde{r}ᵢ with X-coordinate geo-corrected plane Gx provide interval A′B′ for overhead image of threat located at point O₃. Intervals AB and A′B′ define projections of overhead images in geo-corrected plane for different threat locations. Linear mapping between these intervals (ratio of A′B′ to AB) provides the image scaling factor for overhead image transformation.

In operation, the image of the threat object is represented as a set of intensity values of the radiation that passed through the threat object as measured by the detector array. In accordance with one embodiment of the invention, the image of the threat at the correct angle of orientation (correct angle of illumination) can be scaled by the ratio of A′B′/AB. In accordance with one embodiment of the invention, interval AB can be determined by projecting lines from Ob through each vertex or corner of the rectangular box at point O1 and selecting the left most intersection point (min.) and the right most intersection point (max.) as the points that define interval AB. Similarly, interval A′B′ can be determined by projecting lines from Ob through each vertex of the rectangular box at point O3 and selecting the left most intersection point (min.) and the right most intersection point (max.) as the points that define interval A′B′. In this embodiment, the orientation of the rectangular box at O3 is going to be different than the orientation of the rectangular box at O1, because as explained herein, the angle of illumination at O1 is different from the angle of illumination at O3 by α.

In order to determine the appropriate orientation (angle of illumination) of the image of the threat object (taken while the threat object was oriented at arbitrary angle γ and located at O₁) to be inserted at point O₃, the scan of the threat object at the point O₁ must be done at the angle γ-α. In accordance with the invention, the image of the threat object selected for inserting at O3 should be the image of the threat object taken at O1 where the object is oriented at the angle γ-α. This corresponds to the angle of orientation at which an object located at O3 is illuminated. Once the image taken at the proper angle of illumination is selected, the image can be scaled according to the scaling factor and inserted in the image of the object, such as by merging or overlaying one image on another.

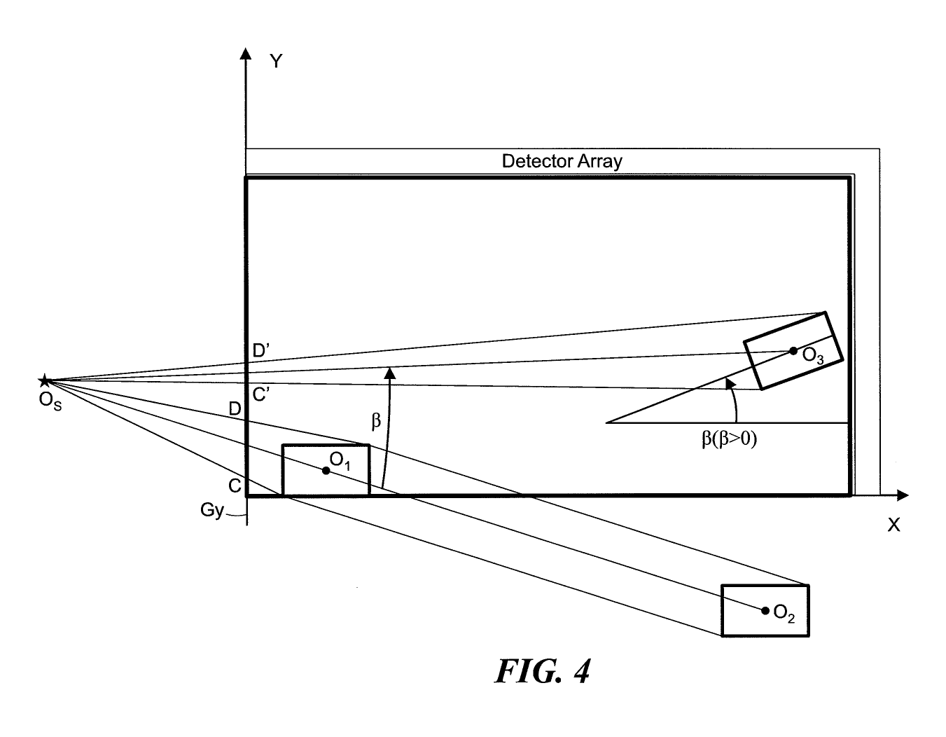

In accordance with one embodiment of the invention, the same image transformation method can be used for side view, as shown in FIG. 4. For the particular case of a scanning system, the Y-coordinate geo-corrected plane coincides with the tunnel T wall. Formulas (1-4) remain valid if applied using the following corrections: the location of the radiation source, point O_{b} becomes point Oₛ and the angle of illumination, angle α becomes angle β. For example, the formulas above can be re-written as

$$\begin{matrix}{O}_{s} {O}_{2} = {O}_{s} {O}_{1} \frac{\vert {O}_{s} {O}_{3} \vert}{\vert {O}_{s} {O}_{1} \vert} . & ( 1 a ) \\ {\tilde{r}}_{i} = {O}_{s} {O}_{2} - {O}_{s} {O}_{1} + {r}_{i} & ( 2 a ) \\ β = arc sin ( \frac{[ {O}_{s} {O}_{1} , {O}_{s} {O}_{3} ] {e}_{z}}{\vert {O}_{s} {O}_{1} \vert \vert {O}_{s} {O}_{3} \vert} ) & ( 3 a ) \\ {R}_{β} = ( \begin{matrix}cos β & - sin β \\ sin β & cos β\end{matrix} ) & ( 4 a )\end{matrix}$$

The intersections of lines Oₛrᵢ with the Y-coordinate geo-corrected plane provide interval CD for the side image of the threat located at point O₁, whereas intersections of lines Oₛ\tilde{r}ᵢ with Y-coordinate geo-corrected plane provide interval C′D′ for the side image of the threat located at point O₃. Intervals CD and C′D′ define the position of side images in Y-coordinate geo-corrected plane for the different threat locations, O1 and O3. Linear mapping between these intervals (the ratio of C′D′ to CD) provides the image scaling factor for the side image transformation.

In operation, the image of the threat object is represented as a set of intensity values of the radiation that passed through the threat object as measured by the detector array. In accordance with one embodiment of the invention, the image of the threat at the correct angle of orientation (correct angle of illumination) can be scaled by the ratio of C′D′/CD. In accordance with one embodiment of the invention, interval CD can be determined by projecting lines from Os through each vertex or corner of the rectangular box at point O1 and selecting the top most intersection point (max.) and the bottom most intersection point (min.) as the points that define interval CD. Similarly, interval C′D′ can be determined by projecting lines from Os through each vertex of the rectangular box at point O3 and selecting the top most intersection point (max.) and the bottom most intersection point (min.) as the points that define interval C′D′. In this embodiment, the orientation of the rectangular box at O3 is going to be different than the orientation of the rectangular box at O1, because as explained herein, the angle of illumination at O1 is different from the angle of illumination at O3 by β.

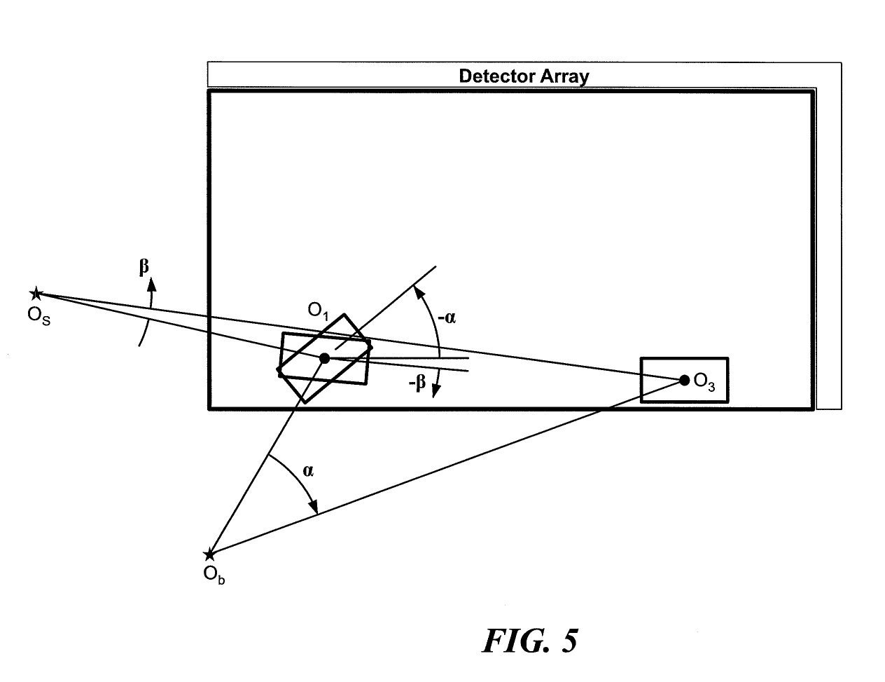

In accordance with one embodiment of the invention, the overhead and side images for the rectangular box located at the point O₃ and oriented at arbitrary angle γ from the images scanned at point O₁ can be determined as follows: 1) the overhead image can be taken at point O₁ at angle γ-α; and 2) the side image can be taken at angle γ-β, as shown in FIG. 5. These images can be scaled according to the determined scaling factor.

In accordance with the invention, the values of angles α and β depend on the location of the illumination (radiation) sources and the locations of point O₁ and point O₃. Point O₃ can have an arbitrary location inside the tunnel T cross-section. For a fixed value of the orientation angle γ, the angles γ-α and γ-β are continuous functions. In accordance with an alternative embodiment of the invention, the system can store in the TIP database only TIP images taken at a discrete set of angles γ-αᵢ and γ-βⱼ at point O₁ and the angular orientation (angle of illumination) of the rectangular box can be approximated at arbitrary point O₃ by selecting a TIP image from the corresponding set of images taken at discrete angles. As one ordinary skill will appreciate, there will be some loss of accuracy depending on the available angles in the set. However, the desired level of accuracy and maximum error can be used to define the set of images and selecting the image that provides the least error (smallest difference between the correct angle of illumination and the closest angle in the set of images). In accordance with the invention, the selection of the set of images can be used to balance accuracy with efficiency.

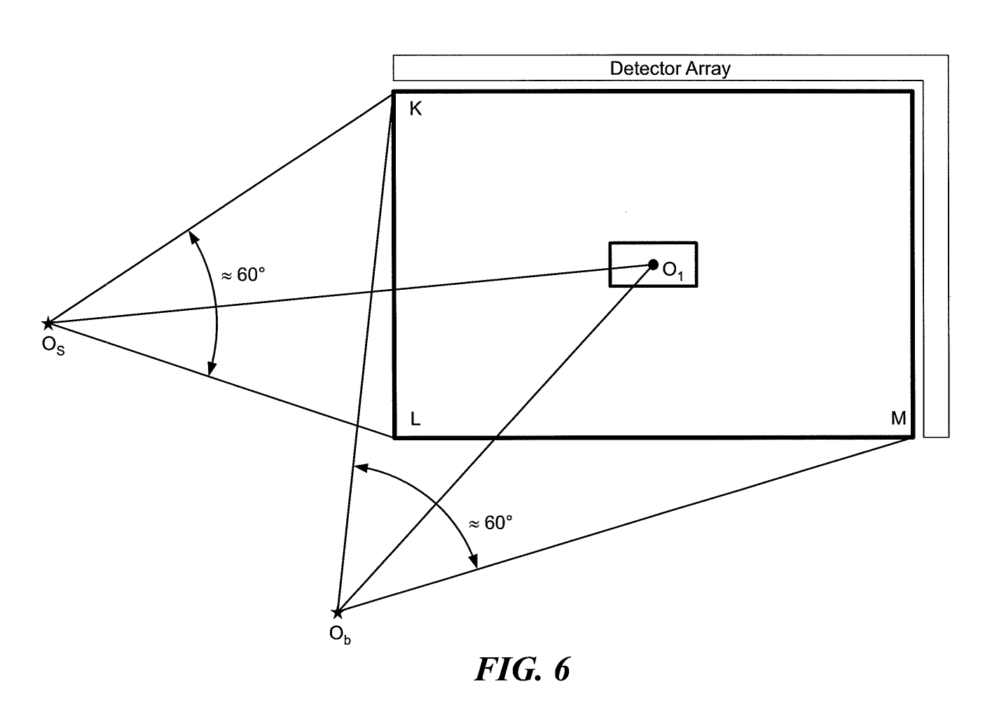

In accordance with the invention, at an arbitrary chosen point O₁ the sets of angles γ-αᵢ and γ-βⱼ are independent and both sets of angles can be used to collect overhead and side images. However, in accordance with an alternative embodiment of the invention, the system can select a point O₁ that allows the system to use a single set of angles with the CT scanning system, for example, having a 40×60 tunnel as shown in FIG. 6. For this system, the angle KOsL is approximately 60° and the angle KObM is approximately 60°. The intersection of the line bisecting angles KOsL and KObM is the point O₁, the center point of the rectangular box. In accordance with one embodiment of the invention, regardless of location of point O₃, both angles α and β change within (−30°, +30° interval and this allows a single set of angle increments (for example, 15°) to be used to collect both side and overhead images and one set of TIP images to be produced and used for both views.

In accordance with one embodiment of the invention, the TIP database can be generated by scanning one or more threat objects or simulated threat object at a central location in the tunnel T, such as shown in FIG. 6. A fixture or jig can be prepared that supports the threat object at one or more discrete angles with respect to the conveyor surface or the illumination sources Ob and Os. The fixture or jig can facilitate the threat object being oriented at angular increments or intervals (for example, about a predefined point in space corresponding to the center of a rectangle enclosing the threat object) as desired, to produce a database of image data, wherein elements of the sets of image data correspond to the threat object oriented at a predefined angular orientation. The image database can include an index that allows the database to be searched according to angular orientation of the image data for a specific threat object. The fixture or jig can be constructed from one or more materials that is either invisible to the radiation produced by the illumination source or can be easily removed from resulting images. The image data collected can be processed to reduce the size of each image to a rectangular or circular shape that encloses the image of the threat object, thus reducing the size of the database. The number of angles that a given threat object can be scanned at and stored in the database can range from one angle to many angles over a range at predefined or random intervals, for example 50 or more angles. However it is desirable to keep the number of angles, and thus images, to a minimum to reduce the size of the database and increase search and data access speeds. In accordance with one embodiment, each threat object can include a different number of images at different angular orientations in order to compensate for the complex geometry of the object. For example, an object having a complex geometry (a gun) can include more angles (and be scanned at smaller angular increments or intervals) than simple object, such as a knife or a mass of simulated explosive.

In this embodiment, the system can also take into consideration that with a multi-view system, the detector arrays are separated in the z direction (direction of the conveyor belt). A multi-view CT system is disclosed in U.S Patent Application Publication No. 2009-0285353, which is hereby incorporated by reference in its entirety. The CT system according to the invention can include a stationary radiation source and one or more detector arrays for measuring radiation passing through objects in the tunnel T. In the multi-view CT system, the CT system can include two or more detector arrays displaced in the Z direction (direction of the conveyor) and additional radiation sources displaced in the Z direction. Where as a standard CT system can include a single radiation source located below the conveyor, the multi-view CT system can include multiple radiation sources at different locations, including, for example, one below the conveyor and one to the side of the tunnel (either above or below the conveyor).

In applying the invention to a multi-view overhead CT scanning system, the image transformations in other overhead views remain the same. Optionally, a correction can be used to account for the shifts in Z direction (direction of the belt) between the central overhead view and one or more of the angled overhead views. These shifts in overhead views can depend on the elevation of point O₁ (or point O₃) above the bottom source and the Zi-coordinate of image in the i^{th} overhead view is related to the Z-coordinate of image in the central overhead view by relation: Z−Zi=H tan(φᵢ), where φᵢ is the angle between central and i^{th} angled overhead planes; H is the elevation of point O₁ (or point O₃) above the bottom source.

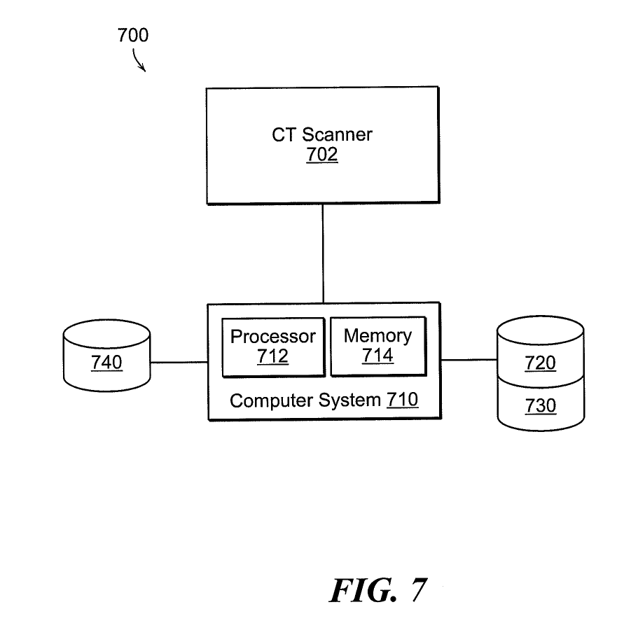

FIG. 7 shows a system 700 in accordance with one embodiment of the invention. The system 700 includes a computer system 710 that can include one or more processors 712 and associated memory 714. The computer system 710 can also include system software 720 adapted to be executed by the computer to control the operation of the system to control the CT scanning system 702, generate images of objects scanned and insert TIPs in accordance with a predefined algorithm or methodology. The system software can include a plurality of software modules constructed to perform specific functions associated with the operation and control of the system. For example, the system software 720 can include a software module for controlling the operation of the CT scanning system 702 and a software module for processing the data provided by the CT scanning system 702 to produce images. In accordance with one embodiment of the invention, the computer system 710 also includes TIP software 730, which can be included as part of a software module, and an associated TIP database 740. The TIP database 740 can include image data for use by the system 710 to insert images of threats in to images of the scanned objects.

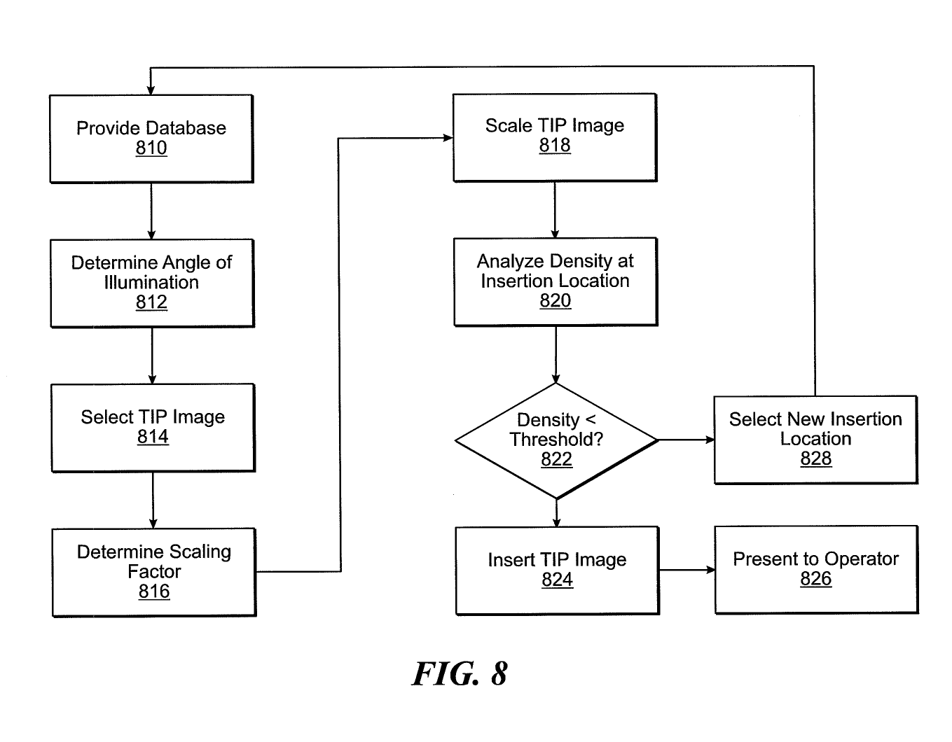

FIG. 8 shows a flow chart of a process for processing and inserting TIP images into images of objects in accordance with one embodiment of the invention. In accordance with the invention, the system software 720 can determine for each object scanned whether a TIP will applied to the image of the object scanned. When software system 720 determined that a TIP will be applied, the TIP software 730 is notified, such as by an API call or a function call to the TIP software 730. The system software 720 can include an indication of the location and type of threat (e.g., a weapon—gun, knife, an explosive or other contraband) or the TIP software 730 can randomly select the type of threat and the location where it is to be inserted.

After the object is scanned and the location and threat type have been determined, the TIP software 730 can generate the appropriate image to be inserted for each view of the system. The TIP system software 730 can include data that provides the location of each radiation source and the center point for each TIP image in the TIP database at 810. In accordance with the invention, at 812, the TIP software 730, knowing the location and orientation of TIP, uses the location of the radiation source and the center point of the TIP image to determine the correct angle of illumination (e.g., α or β) for the TIP. Next, at 814, the TIP software 730 searches the TIP database for the TIP image having the closest angle of illumination to the determined angle of illumination. This can be accomplished by subtracting the determined angle of illumination from each of the TIP image angles of illumination and selecting the image corresponding to the smallest difference. In one embodiment of the invention, the TIP database 740 can include TIP images taken at 5 different angles of illumination (for example, −30°, −15°, 0°, +15°, +30°), allowing for fast selection of the TIP image. Next, at 816, the 730 software 730 can determine the scaling factor, for example, by determining the intervals on a geo-corrected plane. At 818, the scaling factor can be used to scale the TIP image data prior to combining it with the object image data, at 824, to produce the final image of the TIP inserted in the image of the object.

In an alternative embodiment of the invention, the system software 720 or the TIP software 730 can optionally, at 820, analyze the data of the image in the region where the TIP image is to be inserted to determine if the density in the region is above a predefined threshold, at 822, indicating that a solid object is present in the region, and allow the system to select a new location, at 828. This will help avoid inserting the TIP in a location within the object which contains an incompatible element or component. For example, where object is carry-on luggage and the threat is a gun or a knife, this will avoid inserting a TIP the threat appears to be projecting through a laptop computer or a supporting element of the luggage. The process can be repeated until a location is identified where the threat can appropriately be inserted.

This process can be repeated for each view of the CT system, producing multiple TIP images, at least one for each view.

After the location is cleared, at 822, (or a new one selected, at 828) either the system software 720 or TIP software 730 can combine the images at 824, as is well known, such that a combined image can be displayed on the screen to the operator, at 826. The system software 720 can wait for an indication from the operator, such as by pressing a button or touching a location on a touch screen (e.g. where the TIP is found) to allow the system to continue.

The system software 70 can include training features, such that if the operator does not indicate the presence of the TIP and clears the object, the system alerts the operator and highlights the TIP, such as by showing a box around the object on the screen or causing the TIP to glow (e.g., continuously increase or decrease in intensity. The system can also keep track of the operator's performance for later review.

As one of ordinary skill will appreciate, the TIP database can be populated with various sets of image data depending upon the desired speed and accuracy with which the TIP insertion process is to be performed. In accordance with one embodiment of the invention, the maximum range in angle of illumination is approximately 60 degrees and the TIP database includes 5 sets of image data, taken at 15 degree intervals (e.g., −30°, −15°, 0°, +15°, +30°). In alternate embodiments the TIP database can include more or less interval image data. For example, the interval can be 5 degrees and 13 sets of image data. Alternatively, the system can only include one set of image data and only perform the scaling step as described herein.

In accordance with one embodiment of the invention, for a fixed orientation of the threat at angle γ, located at the point O₁, several scans at different angles within the range (−30°+γ, +30°+γ) can be taken and saved in the TIP database. This database can selected and used to obtain transformed images to be inserted at arbitrary point O₃ inside the tunnel according to the following process:
1. Based on the new threat center location, point O₃, calculate angles α and β according to formulas (3) and (3a)
2. Choose images from the TIP image database taken at angles that are the closest to the angle γ-α a for the overhead scan and to the angle γ-β for the side scan. (Image interpolation could be used to improve accuracy.)
3. Calculate intervals AB, A′B′, CD and C′D′
4. Optionally, correct Z-shifts in overhead images if the elevation of point O₃ differs from the elevation point O₁
5. Scale the overhead image(s) from interval AB into interval A′B′ and scale the side image from interval CD into interval C′D′

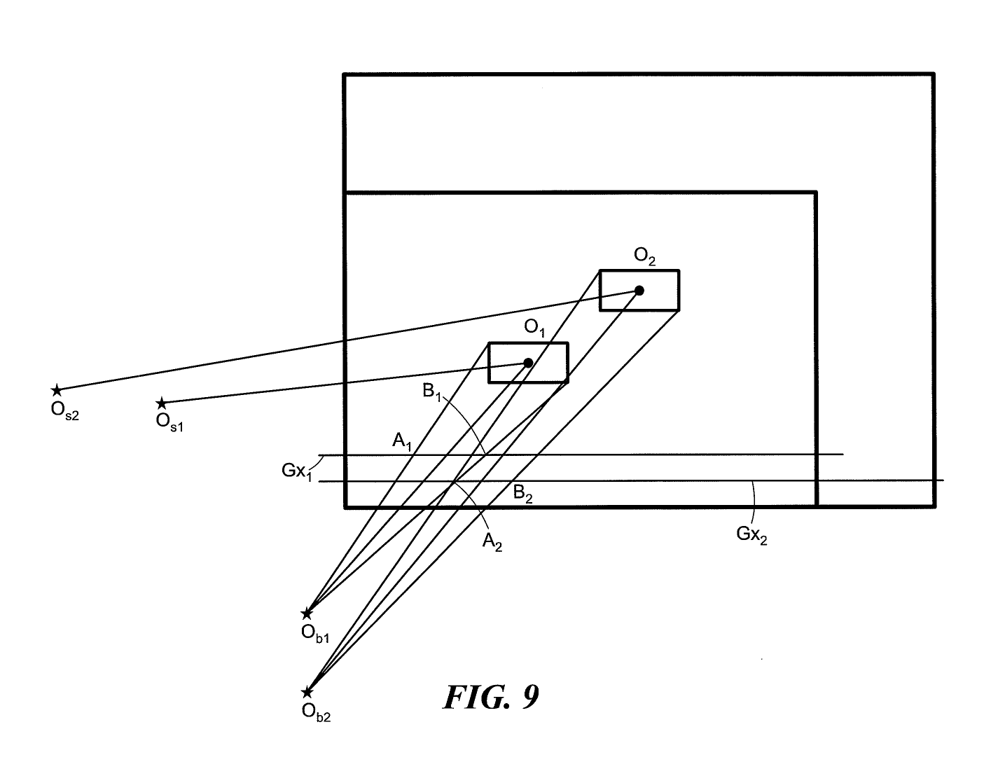

In accordance with an alternative embodiment of the invention, the TIP images in the TIP database can be used with other multi-view CT scanning systems with no or limited modification. The TIP image database collected on a first multi-view CT scanning system (such as one having a 40×60 tunnel T) to be used with a second multi-view CT scanning system (such as one having a 55×75 tunnel T). This embodiment significantly reduces efforts associated with TIP image database collection. The second multi-view CT scanning system can have, for example, a larger tunnel, different locations of bottom and side X-ray sources and different positions of X- and Y-geo-corrected planes than the first multi-view CT scanning system. FIG. 9 shows a comparison of the tunnel cross-section geometry for the first multi-view CT scanning system and the second multi-view CT scanning system with the left bottom corners of both tunnels coincident.

We assume that the location of point O₁ for first multi-view CT scanning system was chosen as it was specified earlier (substantially the center of the tunnel T) and TIP images for the database were collected. The location of point O2 for the second multi-view CT scanning system can be selected using the following relation: Ob2O2∥O_{b1}O₁ and Os2O2∥Os1O1. From this relation, it follows that the bottom and side radiation sources of the second multi-view CT scanning system illuminate an arbitrary rectangular box with a center at point O2 at the same angles as the bottom and side radiation sources of the first multi-view CT system illuminate a rectangular box with the center at point O₁. Knowing vertices of the rectangular box (at O2) rⁱ=rᵢ+O1O2 the system can determine the intersection of lines Ob2rⁱ with the X-coordinate geo-corrected plane for the second multi-view CT scanning system, that define interval A2B2 (the intersection of lines O_{b}rᵢ with the X-coordinate geo-corrected plane for first multi-view CT scanning system define interval A₁B₁) and scale the overhead image from interval A₁B₁ to the interval A2B2 according to the ratio of the intervals.

In accordance with one embodiment of the invention, the Z-shift correction for overhead images can be determine by the formula that follows from the simple geometry relations:

Z−Zⁱ=(Z−Zᵢ)*HO2b/HO1b,

where

HO1b is the elevation of the point O₁ over the source O_{b1} in first multi-view CT scanning system, and

HO2b is the elevation of the point O2 over the source Ob2 in the second multi-view CT scanning system.

The same approach can be used to recalculate side images for TIP database in the second multi-view CT scanning system.

### Numerical Results.

In order to verify the theoretical results developed above we collected sample TIPs database (for first multi-view CT scanning system, Array CT 40×60), that consisted of two guns of different sizes (horizontal and vertical orientations). The point O₁ was chosen as described above. To verify image transformation algorithm we scanned the same objects at different locations in the tunnel. We used several objects for scanning: cell phone, screwdriver, simulated explosive and steak knife arbitrary oriented inside the box. We used 12° angle increment in database collection for these objects. Point O₃ was shifted from the point O₁ by 10 cm in X-direction and by 5 cm in Y-direction. In all pictures shown below the top row of images show scanned results at point O₃ whereas the bottom row of images show transformed results at the same point.

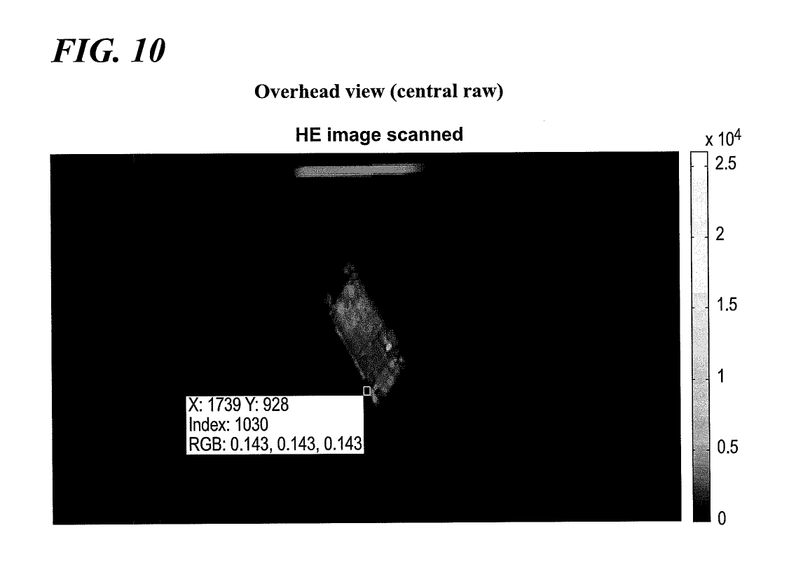

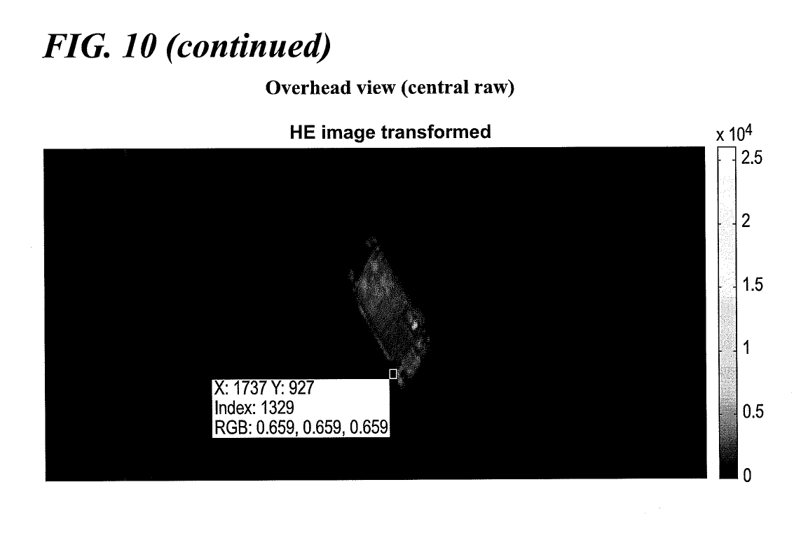

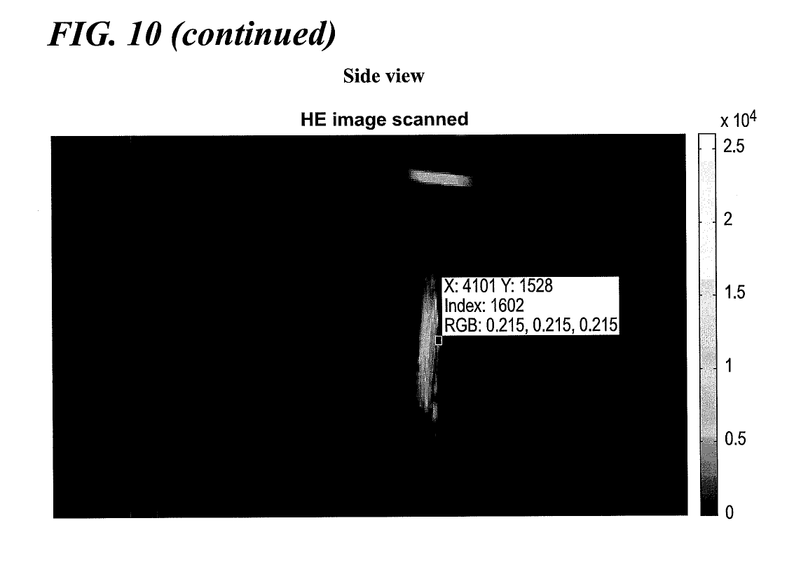

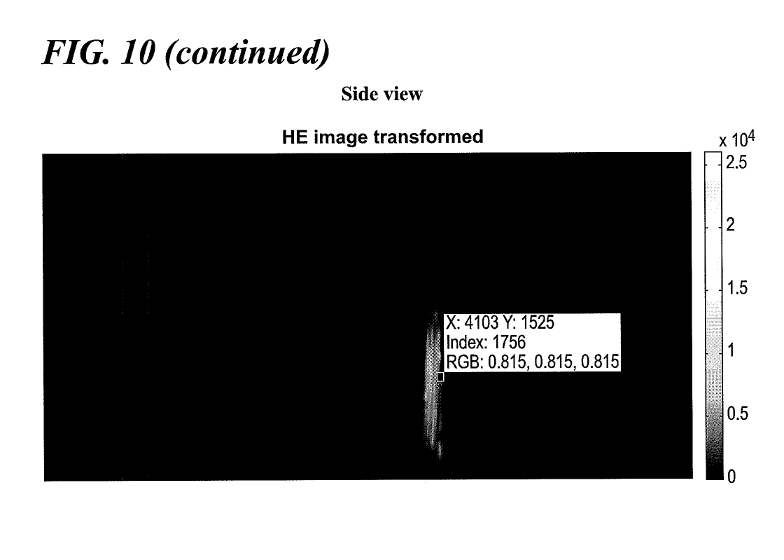

FIG. 10-FIG. 13 show actual images for various objects. In this embodiment, the TIP database included a 12° angle interval in database collection (e.g., −24, −12, 0, +12, +24). These figures show good agreement in image intensity distribution and image location for transformed as compared with the directly scanned images of the objects.

FIG. 10 shows images of a cell phone. The scanned object is shown in the upper row and the transformed image is shown in the bottom row of the figures.

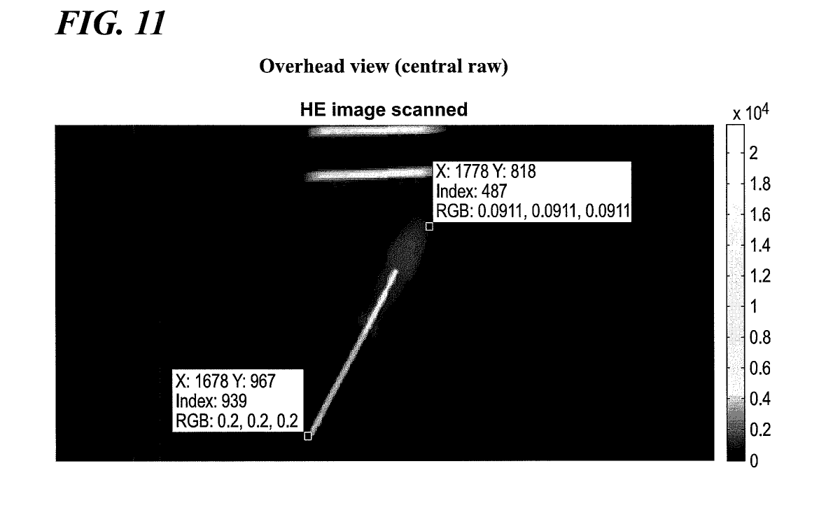

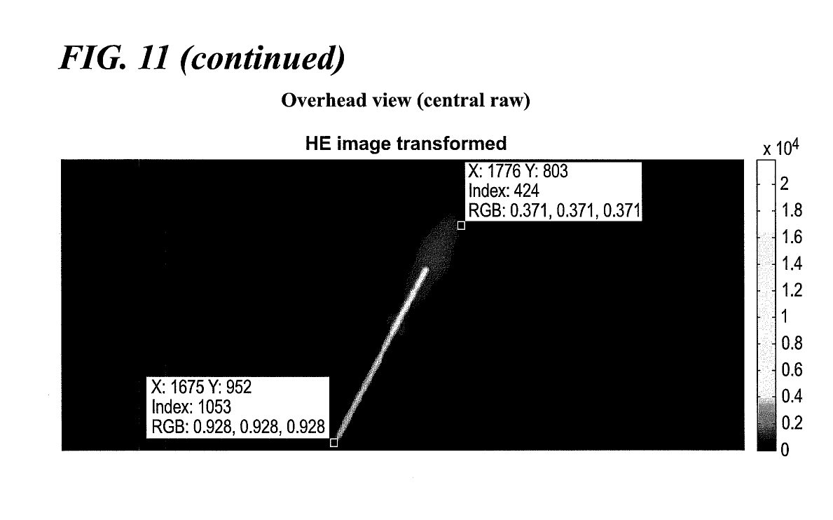

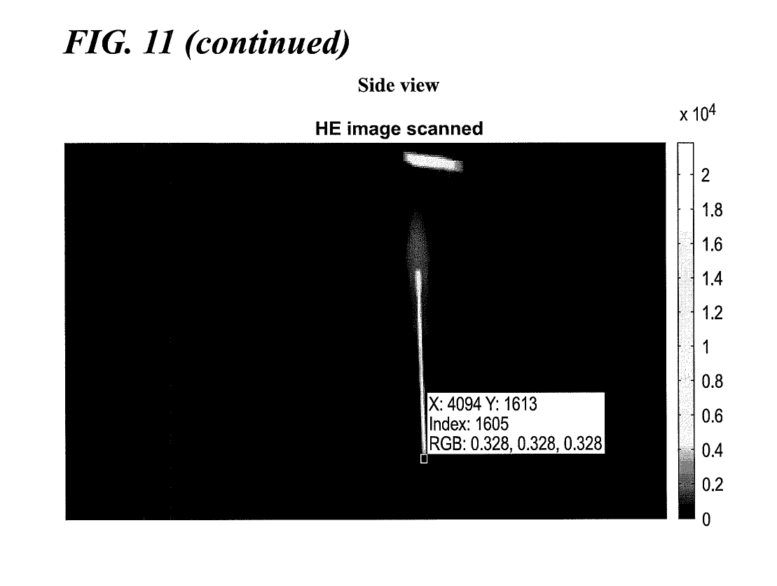

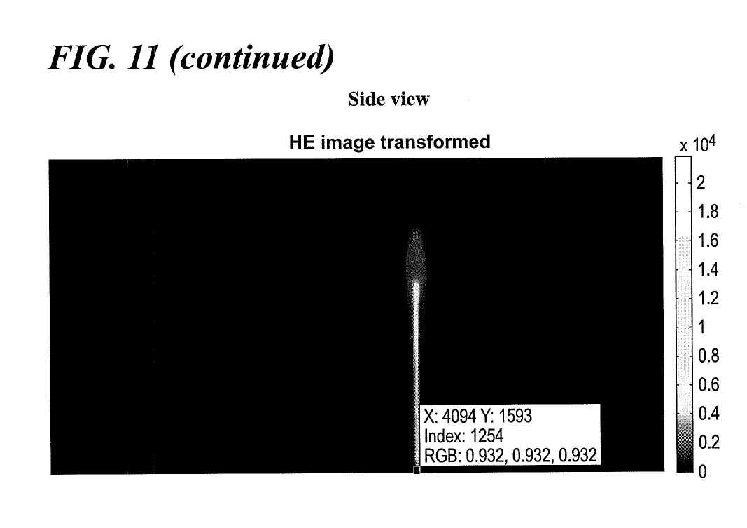

FIG. 11 shows images of a screw driver. The scanned object is shown in the upper row and the transformed image is shown in the bottom row of the figures.

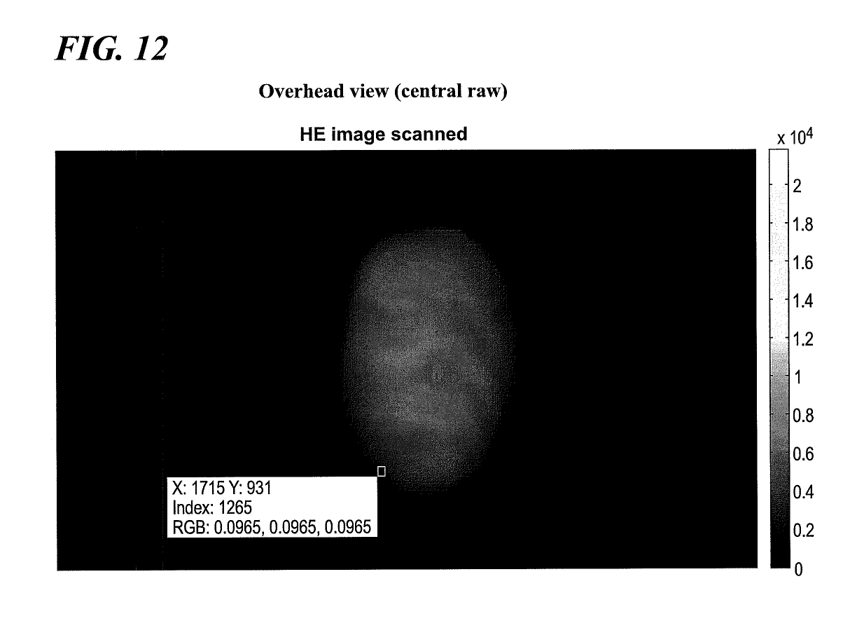

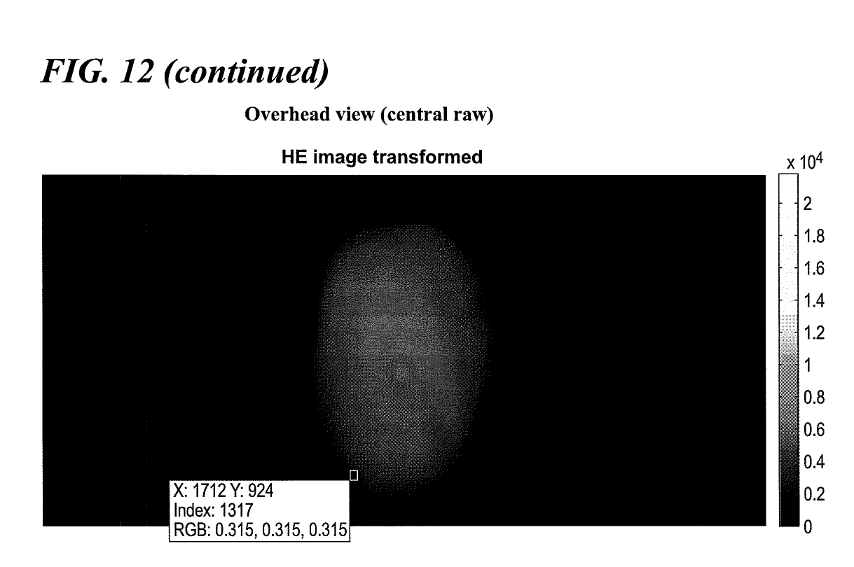

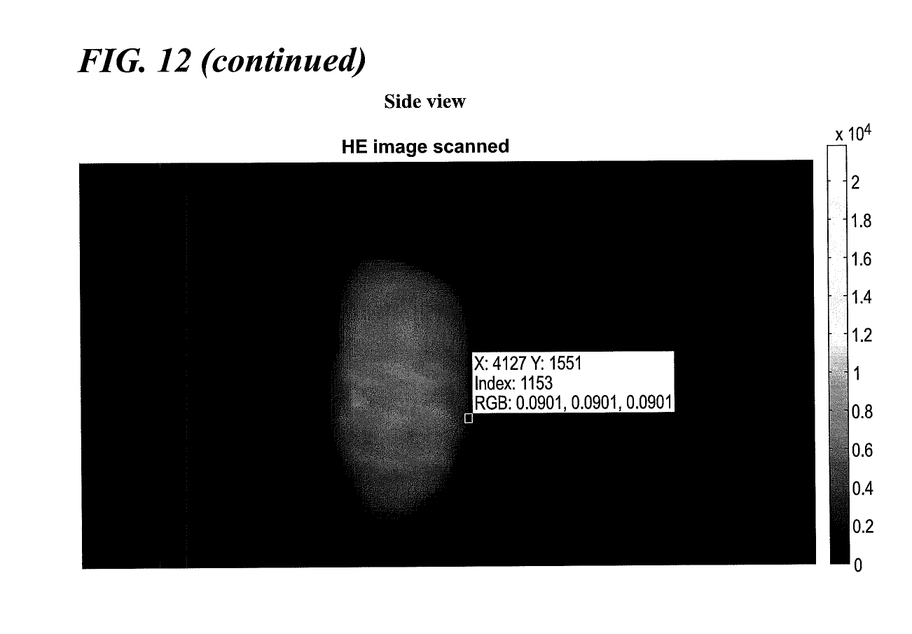

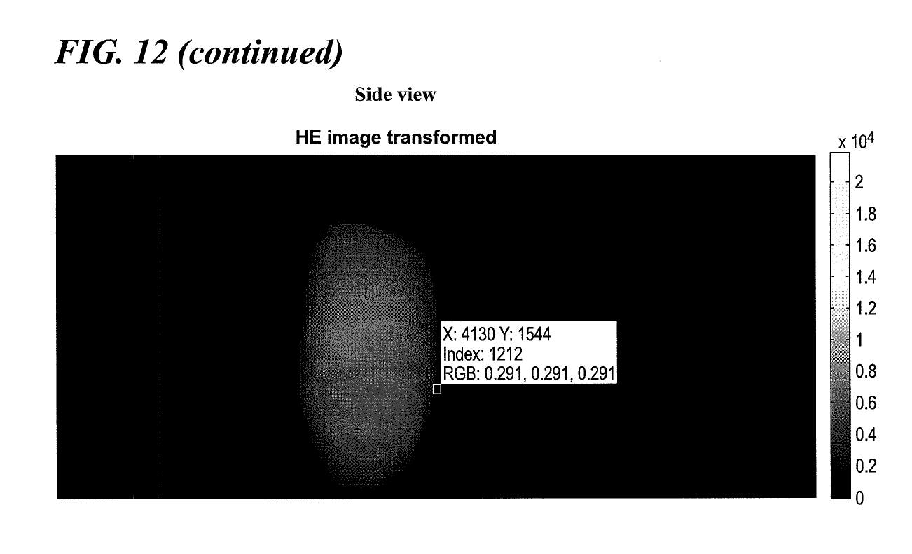

FIG. 12 shows images of a simulated explosive. The scanned object is shown in the upper row and the transformed image is shown in the bottom row of the figures.

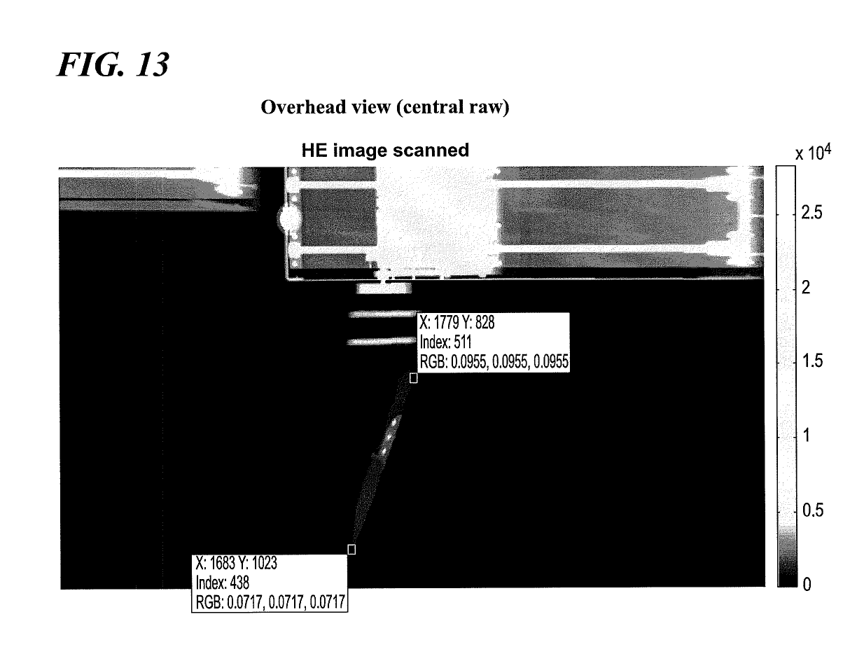

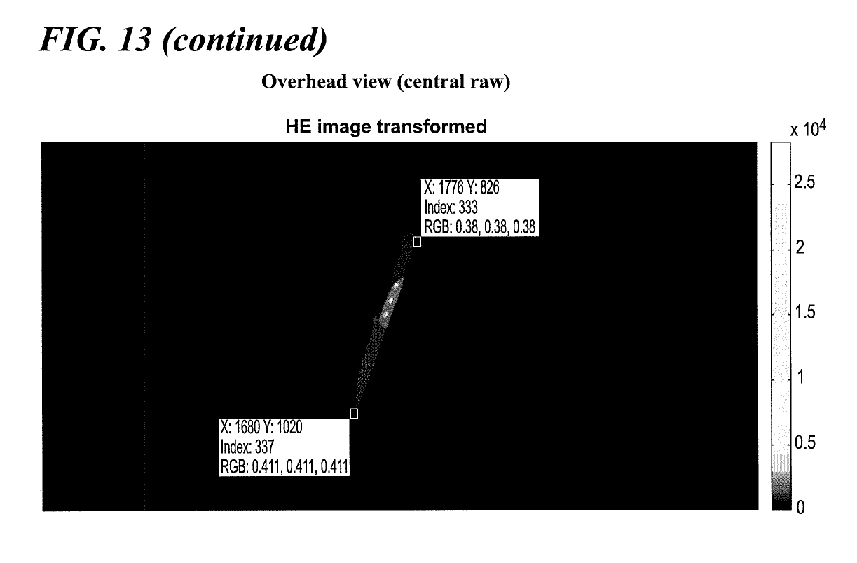

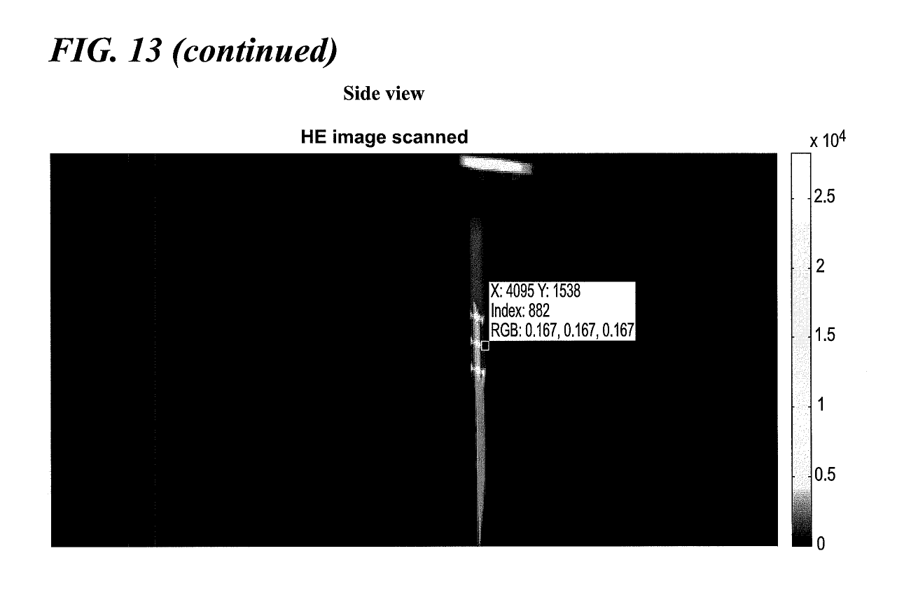

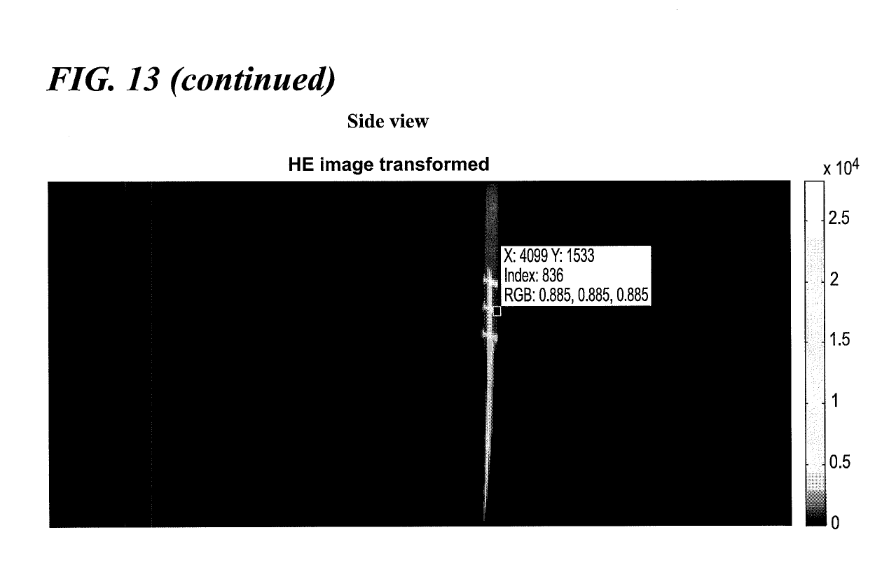

FIG. 13 shows images of a steak knife. The scanned object is shown in the upper row and the transformed image is shown in the bottom row of the figures.

The present invention enables a system that includes a limited library or database of threat images to insert the threat images in to a virtually unlimited number of locations within an image and provide realistic resulting images with improved performance.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A system for performing threat image projection into an image of an object, the system comprising:
a CT scanning system;
at least one computer processor and associated memory;
at least one display;
a database of threat image data, each element of image data being associated with an angle of illumination information with respect to an illumination source and a first location in which the image of the threat was taken;
system software stored in memory and adapted to be executed by the computer processor to control the CT scanning system and produce images of objects scanned by the CT scanning system,
threat image projection software stored in memory and adapted to be executed by the computer processor to produce images of threats,
wherein the threat image projection software receives location information about a location for inserting an image of a threat in the image of the object and selects image data of the threat from the database of threat image data as a function of the location information and a location of the illumination source, determines a scaling factor as a function of the first location and the location information and applies the scaling factor to the image data, to produce scaled image data of the threat.

2. The system according to claim 1 wherein the image database includes threat image data taken of the threat in the first location and in a plurality of angles of illumination.

3. The system according to claim 1 the angle of illumination α is determined according the function:
$$α = arc sin ( \frac{[ {O}_{b} {O}_{1} , {O}_{b} {O}_{3} ] {e}_{z}}{\vert {O}_{b} {O}_{1} \vert \vert {O}_{b} {O}_{3} \vert} )$$
Where ObO1 is a vector extending from a location of the illumination source to the first location, and ObO3 is a vector from the location of the illumination source to the location of the image of the threat.

4. The system according to claim 1 wherein the scaling factor is determined as a function of the distance from the location of the illumination source to the first location and the distance from the location of the illumination source to the location information about a location for inserting an image of a threat.

5. The system according to claim 1 wherein TIP software determines the scaling factor by
defining the image of the threat as a rectangular box,
defining a geo-corrected plane,
projecting a line from the location of the illumination source through each vertex of the rectangular box at the first location to a first set of points intersecting the geo-corrected plane,
determining the first interval as the greatest distance between the first set of points intersecting the geo-corrected plane,
projecting a line from the location of the illumination source through each vertex of the rectangular box at the location for insertion of the threat image to a second set of points intersecting the geo-corrected plane,
determining the second interval as the greatest distance between the second set of points intersecting the geo-corrected plane, and
determining the scaling factor as function of the first interval and second interval.

6. The system according to claim 4 wherein the scaling factor is the ratio of the second interval to the first interval.

7. A method for inserting an image of a threat in to an image of an object, the method comprising:
providing an image database, the image database including threat image data taken of the threat in a first location and at a first angle of illumination with respect to an illumination source;
obtaining a location for insertion of the threat image in the image of the object;
determining the angle of illumination of the threat as a function of the location of the image of the threat, a location of the illumination source and the first location;
selecting threat image data from the image database as function of the angle of illumination;
determining a scaling factor as a function of the determined angle of illumination of the threat and the location of the threat image;
scaling the selected threat image data from the image database;
combining the scaled threat image data with the image of the object; and
presenting the combined image to a user.

8. The method according to claim 7 wherein the image database includes threat image data taken of the threat in the first location and in a plurality of angles of illumination, and information about the corresponding angle of illumination is associated with the threat image data in the image database.

9. The method according to claim 7 wherein the angle of illumination α is determined according the function:
$$α = arc sin ( \frac{[ {O}_{b} {O}_{1} , {O}_{b} {O}_{3} ] {e}_{z}}{\vert {O}_{b} {O}_{1} \vert \vert {O}_{b} {O}_{3} \vert} )$$
Where ObO1 is a vector extending from the location of the illumination source to the first location, and ObO3 is the vector from the location of the illumination source to the location of the image of the threat.

10. The method according to claim 7 wherein determining the scaling factor includes
defining the image of the threat as a rectangular box,
defining a geo-corrected plane,
projecting a line from the location of the illumination source through each vertex of the rectangular box at the first location to a first set of points intersecting the geo-corrected plane,
determining the first interval as the greatest distance between the first set of points intersecting the geo-corrected plane,
projecting a line from the location of the illumination source through each vertex of the rectangular box at the location for insertion of the threat image to a second set of points intersecting the geo-corrected plane,
determining the second interval as the greatest distance between the second set of points intersecting the geo-corrected plane, and
determining the scaling factor as function of the first interval and second interval.

11. The method according to claim 10 wherein the scaling factor is the ratio of the second interval to the first interval.
